(19) United States
(12) Patent Application Publication
(10) Pub. No.: US 2021/0201141 A1
(43) Pub. Date: Jul. 1, 2021

(54) NEURAL NETWORK OPTIMIZATION METHOD, AND NEURAL NETWORK OPTIMIZATION DEVICE

(71) Applicant: Panasonic Intellectual Property Management Co., Ltd., Osaka (JP)

(72) Inventor: Satoshi ISHIBUSHI, Osaka (JP)

(73) Assignee: Panasonic Intellectual Property Management Co., Ltd., Osaka (JP)

(21) Appl. No.: 17/086,864

(22) Filed: Nov. 2, 2020

(30) Foreign Application Priority Data
Dec. 27, 2019 (JP) 2019-238121

(51) Int. Cl. G06N 3/08; G06N 3/04

(52) U.S. Cl. CPC G06N 3/08; G06N 3/0454

(57) ABSTRACT

A neural network optimization method includes: performing first processing of, for each of a plurality of preset layers included in a high precision neural network, performing bit reduction that is processing of reducing bit precision of parameters that constitute the preset layer to derive a degree of influence exerted on the recognition result of the high precision neural network by the bit reduction performed on the layer; and performing second processing of performing the bit reduction on each of at least one of the plurality of preset layers included in the high precision neural network that is identified based on the degree of influence derived for each of the plurality of preset layers to generate a bit reduction neural network.

### CROSS REFERENCE TO RELATED APPLICATION

The present application is based on and claims priority of Japanese Patent Application No. 2019-238121 filed on Dec. 27, 2019.

### FIELD

The present disclosure relates to a method and a device for optimizing neural networks.

### BACKGROUND

A convolutional neural network used for image recognition requires, in order to achieve a high level of recognition accuracy, a large amount of filter data in each intermediate layer included in the convolutional neural network. However, in an installation environment in which the convolutional neural network is installed on a facility other than a server (for example, an automobile or the like), the computing resource used for the convolutional neural network is limited. Accordingly, conventionally, a parameter setting method for a convolutional neural network has been proposed in which the bit width of filter data is changed to a small width without reducing the recognition accuracy of the convolutional neural network to a level less than the required accuracy (see, for example, Patent Literature (PTL) 1). That is, with the parameter setting method, the bit precision of layers included in the neural network is reduced, and the neural network is thereby optimized for its installation environment. Accordingly, it can be said that the parameter setting method described above is a neural network optimization method.

### CITATION LIST

### Patent Literature

PTL 1: Japanese Unexamined Patent Application Publication No. 2018-142049

### SUMMARY

However, the parameter setting method according to PTL 1 can be improved upon.

In view of this, the present disclosure provides a neural network optimization method capable of improving upon the above related art.

A neural network optimization method according to one aspect of the present disclosure includes: performing first processing of, for each of a plurality of preset layers included in a first neural network that outputs, upon input of evaluation data that indicates an object, a recognition result of the object, performing bit reduction that is processing of reducing bit precision of parameters that constitute the preset layer to derive a degree of influence exerted on the recognition result of the first neural network by the bit reduction performed on the layer; and performing second processing of performing the bit reduction on each of at least one of the plurality of preset layers included in the first neural network that is identified based on the degree of influence derived for each of the plurality of preset layers to generate a second neural network.

The generic or specific aspects of the present disclosure may be implemented by a system, an integrated circuit, a computer program or a computer readable recording medium such as a CD-ROM, or may be implemented by any combination of a system, a method, an integrated circuit, a computer program, and a recording medium. Also, the recording medium may be a non-transitory recording medium.

A neural network optimization method according to one aspect of the present disclosure is capable of improving upon the above related art.

Further advantages and effects of one aspect of the present disclosure will become apparent from the specification and the drawings. The advantages and/or effects are provided by some embodiments and features described in the specification and the drawings, but not necessarily all of them need to be provided to obtain one or more identical features.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a diagram illustrating generation and conversion of a neural network.

FIG. 2 is a diagram showing an example of conversion of a neural network.

FIG. 3 is a diagram showing the overview of a neural network optimization method envisaged from a conventional technique.

FIG. 4 is a block diagram showing a configuration example of a neural network optimization device according to an embodiment.

FIG. 5 is a diagram illustrating bit precision conversion according to the embodiment.

FIG. 6 is a diagram showing the overview of a neural network optimization method according to the embodiment.

FIG. 7 is a diagram illustrating processing performed by a low precision NN generator according to the embodiment.

FIG. 8 is a diagram illustrating an example of processing performed by a degree-of-influence deriver according to the embodiment.

FIG. 9 is a diagram showing an example of evaluation values according to the embodiment.

FIG. 10 is a diagram illustrating a specific example of processing performed by the degree-of-influence deriver according to the embodiment.

FIG. 11 is a diagram showing an example of the degree of influence derived by a degree-of-influence deriver according to the embodiment.

FIG. 12 is a flowchart illustrating an example of overall processing performed by the neural network optimization device according to the embodiment.

FIG. 13 is a flowchart illustrating an example of processing performed by the degree-of-influence deriver according to the embodiment.

FIG. 14 is a diagram schematically showing an example of threshold value utilization identification processing performed by a bit reduction layer identifier according to the embodiment.

FIG. 15 is a flowchart illustrating the example of threshold value utilization identification processing performed by the bit reduction layer identifier according to the embodiment.

FIG. 16 is a diagram schematically showing an example of minimum-degree-of-influence identification processing performed by the bit reduction layer identifier according to the embodiment.

FIG. 17 is a flowchart showing the example of minimum-degree-of-influence identification processing performed by the bit reduction layer identifier according to the embodiment.

FIG. 18 is a diagram schematically showing an example of degree-of-influence update identification processing performed by the bit reduction layer identifier according to the embodiment.

FIG. 19 is a flowchart illustrating another example of overall processing performed by the neural network optimization device according to the embodiment.

### DESCRIPTION OF EMBODIMENT

(Underlying Knowledge Forming the Basis of the Present Disclosure)

Generally, a neural network used for a task such as image recognition or object detection is generated in a high precision bit format. However, in the case where the neural network is installed in an installation environment with limited computing resources, the neural network is converted into a low precision bit format.

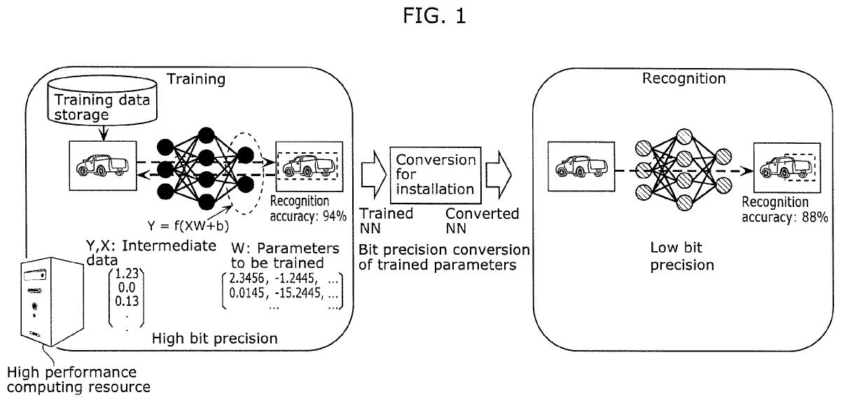

FIG. 1 is a diagram illustrating generation and conversion of a neural network.

A neural network in a high precision bit format is generated through training. In the training, a plurality of image data stored in a training data storage and the type of objects reflected in the plurality of image data are used as training data. Through the training, a trained neural network is generated. The trained neural network outputs, upon input of image data, a recognition accuracy (also referred to as score) as a recognition result of an object reflected in the input image data.

Also, a trained neural network as described above includes a plurality of layers. Output data Y output from each of the layers is indicated by Y=f(XW+b). That is, output data Y output from one layer is represented by a function that uses input data X, weight W, and bias b. Input data X is output from a layer adjacent to the one layer on the input layer side, and output data Y and input data X are also referred to as intermediate data. Weight W and bias b are parameters of the one layer and are set through training.

In the training as described above, in order to achieve a high level of object recognition accuracy, for example, a bit format with high bit precision such as 32-bit float is used for the parameters and the intermediate data described above. Accordingly, for example, with the use of a high performance computing resource such as a GPU (Graphics Processing Unit) included in a server, a trained neural network with high bit precision (trained NN in FIG. 1) is generated.

However, in an installation environment in which the neural network is installed in a facility (for example, an automobile, or the like), other than the server, that does not have a high performance computing resource, the computing resources used for the neural network are limited. Accordingly, the trained neural network with high bit precision is converted into a neural network with low bit precision (converted NN in FIG. 1) through conversion for installation.

In the conversion for installation described above, the bit precision of the parameters and output data Y that constitute each layer included in the trained neural network is converted. That is, the bit precision of the parameters and output data Y is reduced. For example, the 32-bit float is converted into 8-bit int or the like. The bit precision of the neural network that includes layers on which bit precision conversion as described above has been performed is low. Accordingly, the converted neural network can recognize the object reflected in the image data at a high speed even if the computing resources are less. In the installation environment, the converted neural network with low bit precision as described above is mounted. For example, the converted neural network mounted on an automobile outputs, upon input of image data obtained by capturing with an on-board camera, the recognition accuracy of an object reflected in the image data.

However, if the bit precision of all of the layers included in the trained neural network with high bit precision is reduced, the recognition accuracy may decrease significantly. Accordingly, for example, the reduction in the recognition accuracy can be suppressed by causing the plurality of layers included in the trained neural network to have different bit precisions.

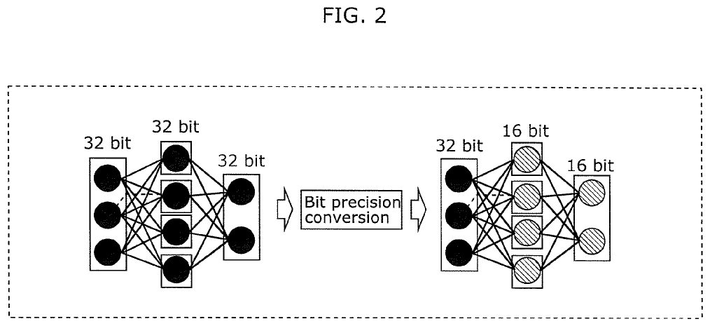

FIG. 2 is a diagram showing an example of conversion of a neural network.

For example, all of the layers included in the trained neural network with high bit precision have a 32 bit precision. Conversion for installation as described above is performed on the trained neural network. That is, bit precision conversion is performed. In the conversion, the trained neural network is converted into a neural network that includes a plurality of layers that have different bit precisions. For example, the converted neural network includes a layer with a 32 bit precision and layers with a 16 bit precision.

With the conversion for installation described above, the reduction in the recognition accuracy of the neural network can be suppressed.

However, for example, in a neural network optimization method that can be envisaged from the parameter setting method disclosed in PTL 1 described above, layers on which bit reduction is performed are empirically determined. The bit reduction is processing of reducing bit precision, and is processing of converting a high bit precision into a low bit precision. In other words, the bit reduction is quantization or processing of shortening bit width.

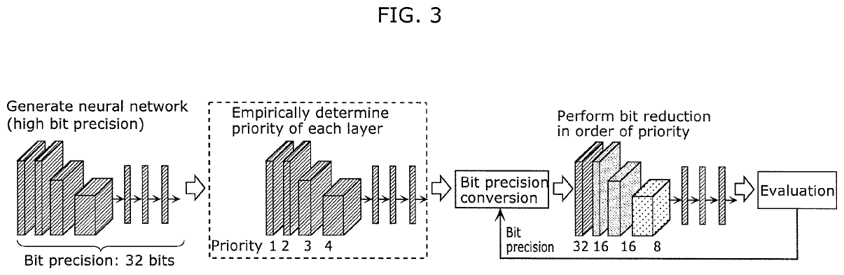

FIG. 3 is a diagram showing the overview of a neural network optimization method envisaged from a conventional technique.

In the neural network optimization method, as shown in FIG. 3, first, a neural network with high bit precision is generated. For example, the layers included in the neural network each have a 32 bit precision. The priority of the layers included in the neural network on which bit reduction is performed is empirically determined. After that, bit reduction, or in other words, quantization is performed on the layers based on the determined order of priority. For example, first, bit reduction is performed on the layer determined as having the highest priority, and the recognition accuracy of a neural network generated through the bit reduction is evaluated. Then, if the recognition accuracy is higher than the required accuracy, furthermore, bit reduction is performed on the layer determined as having the next highest priority, and the recognition accuracy of a neural network generated through the bit reduction is evaluated. By repeating bit reduction and evaluation in the manner described above, neural network optimization is performed.

However, with the neural network optimization method, bit reduction is performed on empirically selected layers, and thus it is not possible to perform systematic optimization. As a result, in the case of a neural network with high bit precision that includes a large number of layers, it is difficult to find out an optimum solution.

In order to solve the problem described above, a neural network optimization method according to one aspect of the present disclosure includes: performing first processing of, for each of a plurality of preset layers included in a first neural network that outputs, upon input of evaluation data that indicates an object, a recognition result of the object, performing bit reduction that is processing of reducing bit precision of parameters that constitute the preset layer to derive a degree of influence exerted on the recognition result of the first neural network by the bit reduction performed on the layer; and performing second processing of performing the bit reduction on each of at least one of the plurality of preset layers included in the first neural network that is identified based on the degree of influence derived for each of the plurality of preset layers to generate a second neural network. For example, in the first processing, when deriving the degree of influence for a deriving target layer that is one of the plurality of preset layers included in the first neural network, the degree of influence of the deriving target layer may be derived by calculating a difference between a first evaluation value and a second evaluation value, the first evaluation value being a value based on a recognition result obtained when the bit reduction is not performed on the deriving target layer, and the second evaluation value being a value based on a recognition result obtained when the bit reduction is performed on the deriving target layer.

With this configuration, the degree of influence of each of the plurality of layers included in the first neural network (for example, high precision neural network) is derived, and bit reduction is performed on the at least one layer identified based on the degree of influence. Accordingly, bit reduction can be performed on the layers that are identified quantitatively rather than empirically. Accordingly, it is possible to appropriately find out an optimum solution for the neural network. That is, it is possible to appropriately find out a neural network in which the amount of data is reduced while suppressing a reduction in recognition accuracy and that is optimal for, for example, the installation environment.

That is, with the parameter setting method of PTL 1 described above is problematic in that it is not possible to perform bit precision reduction on appropriate layers, and it is difficult to find out an optimum solution for the neural network. However, with the present disclosure, it is possible to appropriately find out an optimum solution for the neural network.

Also, in the first processing, a low precision neural network may be generated by performing the bit reduction on each of the plurality of preset layers included in the first neural network, output data output from each of a plurality of layers included in the low precision neural network may be acquired by forward propagation of the low precision neural network upon input of the evaluation data, when, in the first neural network, a preceding adjacent layer is present adjacent to the deriving target layer on an input side, and a succeeding adjacent layer is present adjacent to the deriving target layer on an output side: the output data from a low precision preceding adjacent layer that is one of the plurality of layers included in the low precision neural network and corresponds to the preceding adjacent layer may be input into the deriving target layer on which the bit reduction is not performed, as preceding adjacent layer output data; the first evaluation value may be derived based on a recognition result obtained by forward propagation of the first neural network upon input of the preceding adjacent layer output data into the deriving target layer; the output data from a low precision deriving target layer that is one of the plurality of layers included in the low precision neural network and corresponds to the deriving target layer may be input into the succeeding adjacent layer on which the bit reduction is not performed, as deriving target layer output data; and the second evaluation value may be derived based on a recognition result obtained by forward propagation of the first neural network upon input of the deriving target layer output data into the succeeding adjacent layer.

With this configuration, the degree of influence of the deriving target layer is derived in the case where the layers from the input layer to the preceding adjacent layer included in the first neural network have a low bit precision, and the layers from the succeeding adjacent layer to the output layer included in the first neural network have a high bit precision. That is, in this case, the difference between the first evaluation value obtained when bit reduction is not performed on the deriving target layer and the second evaluation value obtained when bit reduction is performed on the deriving target layer is derived as the degree of influence of the deriving target layer. Accordingly, the degree of influence exerted on the recognition result of the first neural network can be derived more significantly and more appropriately according to whether or not bit reduction is performed on the deriving target layer. As a result, it is possible to more appropriately find out an optimum solution for the neural network.

Also, in the second processing, at least one layer whose degree of influence is less than or equal to a threshold value may be identified from among the plurality of preset layers included in the first neural network, and the bit reduction may be performed on each of the at least one layer identified.

With this configuration, at least one layer to be subjected to bit reduction can be easily identified. Furthermore, by setting the threshold value, a plurality of layers can be identified, and thus neural network optimization can be facilitated.

Also, the neural network optimization method may further include: performing third processing of deriving a third evaluation value that is an evaluation value based on a recognition result output upon input of the evaluation data into the second neural network, the third evaluation value increasing with an increase in recognition accuracy of the object; and performing fourth processing of updating the threshold value by increasing the threshold value when the third evaluation value is greater than a target value, and the second processing, the third processing, and the fourth processing may be repeatedly executed by using the second neural network as a new first neural network and the threshold value updated, and in the second processing that is repeatedly executed, at least one layer whose degree of influence is less than or equal to the threshold value updated may be identified from at least one of the plurality of preset layers included in the new first neural network, the at least one of the plurality of preset layers not being subjected to the bit reduction yet.

With this configuration, as long as the third evaluation value is greater than the target value, the threshold value is updated, and bit reduction is repeated. Accordingly, it is possible to appropriately find out a neural network that does not have recognition accuracy that is more than necessary.

Also, in the second processing, one layer whose degree of influence is lowest may be identified from among the plurality of preset layers included in the first neural network, and the bit reduction may be performed on the one layer identified.

With this configuration, layers to be subjected to bit reduction can be easily identified without performing preliminary processing such as setting threshold values.

Also, the neural network optimization method may further include: performing third processing of deriving a third evaluation value that is an evaluation value based on a recognition result output upon input of the evaluation data into the second neural network, the third evaluation value increasing with an increase in recognition accuracy of the object, and the second processing and the third processing may be repeatedly executed by using the second neural network as a new first neural network when the third evaluation value is greater than a target value, and in the second processing that is repeatedly executed, one layer whose degree of influence is lowest may be identified from among at least one of the plurality of preset layers included in the new first neural network, the at least one of the plurality of preset layers not being subjected to the bit reduction yet.

With this configuration, as long as the third evaluation value is greater than the target value, bit reduction is performed on the plurality of layers sequentially from the layer with the lowest degree of influence. Accordingly, it is possible to appropriately find out a neural network that does not have recognition accuracy that is more than necessary.

Also, the neural network optimization method may further include: performing third processing of deriving a third evaluation value that is an evaluation value based on a recognition result output upon input of the evaluation data into the second neural network, the third evaluation value increasing with an increase in recognition accuracy of the object, and the first processing, the second processing, and the third processing may be repeatedly executed by using the second neural network as a new first neural network when the third evaluation value is greater than a target value.

With this configuration, the second neural network (for example, bit reduction neural network) is treated as a new first neural network, and the degree of influence of each of the plurality of layers included in the new first neural network is derived. Then, by using the degrees of influence, layers to be subjected to bit reduction are identified from among the plurality of layers included in the new first neural network. Accordingly, appropriate degrees of influence can be used for the new first neural network without using old degrees of influence derived for the original first neural network. As a result, it is possible to more appropriately find out an optimum solution for the neural network.

Also, in the neural network optimization method, when the second processing and the third processing are repeatedly executed, and the third evaluation value derived in the third processing executed last is less than the target value, the second neural network generated by the second processing executed immediately before the second processing performed last may be output as a final neural network.

With this configuration, even if the third evaluation value of the second neural network generated in the last second processing is less than the target value, the third evaluation value of the second neural network generated in the second processing performed immediately before is greater than the target value. The second neural network from which the third evaluation value that is greater than the target value is derived is output as the final neural network, and thus it is possible to more appropriately find out a neural network in which the amount of data is sufficiently reduced while keeping the recognition accuracy at a certain level.

Hereinafter, an embodiment will be described specifically with reference to the drawings.

Note that the embodiment described below shows a generic or specific example of the present disclosure. The numerical values, shapes, materials, structural elements, the arrangement and connection of the structural elements, steps, the order of the steps, and the like shown in the following embodiment are merely examples, and therefore are not intended to limit the scope of the present disclosure. Also, among the structural elements described in the following embodiment, structural elements not recited in any one of the independent claims are described as arbitrary structural elements.

Note also that the diagrams are schematic representations, and thus are not necessarily true to scale. Also, in the diagrams, structural elements that are the same are given the same reference numerals.

### EMBODIMENT

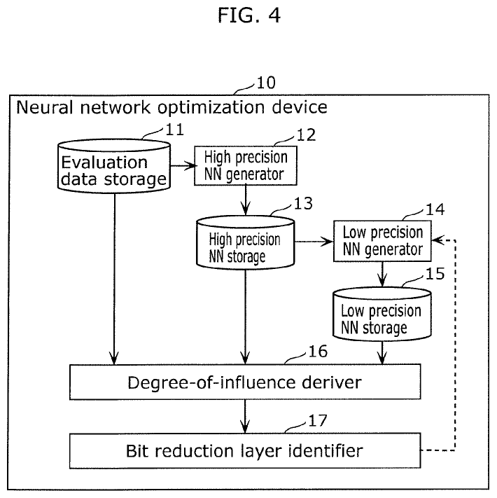

FIG. 4 is a block diagram showing a configuration example of a neural network optimization device according to the present embodiment.

Neural network optimization device 10 according to the present embodiment is a device that can appropriately find out an optimum solution for a neural network, and includes evaluation data storage 11, high precision NN generator 12, high precision NN storage 13, low precision NN generator 14, low precision NN storage 15, degree-of-influence deriver 16, and bit reduction layer identifier 17.

Evaluation data storage 11 stores therein a plurality of evaluation data for evaluating neural networks. For example, these evaluation data are data that indicate images in which objects are reflected, or in other words, image data.

High precision NN generator 12 generates a neural network with high bit precision through training of neural networks by using the plurality of evaluation data stored in evaluation data storage 11. In the training, for example, the plurality of evaluation data stored in evaluation data storage 11 and the type of objects reflected in these evaluation data are used as training data. Hereinafter, the neural network with high bit precision will also be referred to as “high precision neural network” or “first neural network”. Then, high precision NN generator 12 stores the generated high precision neural network in high precision NN storage 13.

Low precision NN generator 14 generates a neural network with low bit precision from the high precision neural network stored in high precision NN storage 13. Hereinafter, the neural network with low bit precision will also be referred to as “low precision neural network”. Then, low precision NN generator 14 stores the low precision neural network in low precision NN storage 15.

Degree-of-influence deriver 16 derives the degree of influence of each of the plurality of preset layers included in the high precision neural network stored in high precision NN storage 13. Each of the plurality of layers is composed of a plurality of parameters as shown in FIG. 1.

Bit reduction layer identifier 17 identifies, based on the degree of influence derived for each of the plurality of layers by degree-of-influence deriver 16, a layer to be subjected to bit reduction from among the layers. Then, bit reduction layer identifier 17 performs bit reduction on the layer identified from among the plurality of preset layers included in the high precision neural network to generate a bit reduction neural network. The bit reduction neural network will also be referred to as “second neural network”.

Also, evaluation data storage 11, high precision NN storage 13, and low precision NN storage 15 according to the present embodiment are hard disks, RAMs (Read Only Memory), ROMs (Random Access Memory), semiconductor memories, or the like. The storages may be either volatile or non-volatile.

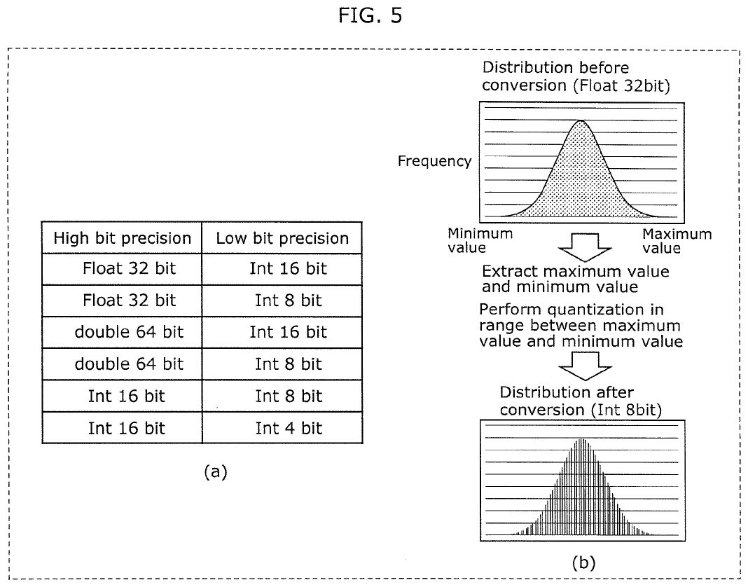

FIG. 5 is a diagram illustrating bit precision conversion according to the present embodiment.

For example, as shown in (a) in FIG. 5, neural network optimization device 10 according to the present embodiment converts the bit precision of parameters that constitute a layer included in the neural network from a high bit precision to a low bit precision. Such conversion is processing of reducing bit precision, and is also called “bit reduction”. For example, 32-bit float is converted to 16-bit int or 8-bit int, and 64-bit double is converted into 16-bit int or 8-bit int. 16-bit int is converted into 8-bit int or a 4-bit int. As will be described later, such bit precision conversion, or in other words, bit reduction is performed by each of low precision NN generator 14, degree-of-influence deriver 16, and bit reduction layer identifier 17.

Also, such bit precision conversion is implemented by quantization of parameters. One of two graphs shown in (b) in FIG. 5 (namely, the graph on the upper side of FIG. 5) is a graph that shows the distribution of values indicated by the parameters of the layers included in the neural network before conversion. For example, the values indicated by the parameters before conversion are represented by 32-bit float. In the graph, the horizontal axis indicates values indicated by the parameters, and the vertical axis indicates the frequency of appearance of the parameters that indicate the values.

For example, in the quantization of the parameters, neural network optimization device 10 first extracts a maximum value and a minimum value from among the values indicated by the parameters. Then, neural network optimization device 10 divides the range between the minimum value and the maximum value by the number that can be represented by the bit precision after conversion, and converts values represented by the bit precision before conversion to values represented by the bit precision after conversion.

By doing so, in the two graphs shown in (b) in FIG. 5, the graph on the upper side is converted into the graph on the lower side. The graph on the lower side shown in (b) in FIG. 5 is a graph that indicates the distribution of values indicated by the parameters after conversion included in the layers of the neural network. For example, the values indicated by the parameters after conversion are represented by 8-bit int.

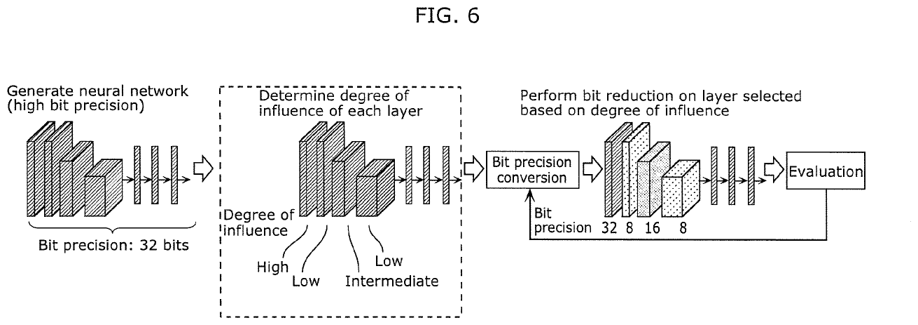

FIG. 6 is a diagram showing the overview of a neural network optimization method according to the present embodiment.

First, as shown in FIG. 6, high precision NN generator 12 of neural network optimization device 10 according to the present embodiment generates a high precision neural network through training. For example, the bit precision of layers included in the high precision neural network is 32 bit.

Then, degree-of-influence deriver 16 derives the degree of influence for each layer included in the high precision neural network by using the low precision neural network generated by low precision NN generator 14. The degree of influence is indicated by a numerical value that represents the level of influence exerted on the recognition result of the high precision neural network by the bit reduction performed on the layer.

That is, degree-of-influence deriver 16 according to the present embodiment performs first processing of, for each of a plurality of preset layers included in a high precision neural network that outputs, upon input of evaluation data that indicates an object, a recognition result of the object, performing bit reduction that is processing of reducing bit precision of parameters that constitute the preset layer to derive a degree of influence exerted on the recognition result of the high precision neural network by the bit reduction performed on the layer. Degree-of-influence deriver 16 according to the present embodiment may be configured as a first processing unit that performs the first processing. Alternatively, a constituent element group that includes degree-of-influence deriver 16 and low precision NN generator 14 may be configured as the first processing unit that performs the first processing.

Next, bit reduction layer identifier 17 selects a layer to be subjected to bit reduction based on the degree of influence of each layer derived by degree-of-influence deriver 16, and performs bit precision conversion, or in other words, bit reduction on the selected layer. That is, bit reduction layer identifier 17 according to the present embodiment performs second processing of performing the bit reduction on each of at least one of the plurality of layers included in the high precision neural network that is identified based on the degree of influence derived for each of the plurality of layers to generate a bit reduction neural network. Bit reduction layer identifier 17 according to the present embodiment may be configured as a second processing unit that performs the second processing.

Then, bit reduction layer identifier 17 evaluates the recognition result of the bit reduction neural network. If an evaluation value based on the recognition result is greater than a target value, bit reduction layer identifier 17 further performs bit reduction on another at least one layer identified based on the degree of influence. By repeating bit reduction and evaluation in the manner described above, neural network optimization is performed.

With this configuration, in the neural network optimization method according to the present embodiment, bit reduction is performed on the layers selected or identified quantitatively rather than empirically. Accordingly, it is possible to appropriately find out an optimum solution for the neural network. That is, it is possible to appropriately find out a neural network in which the amount of data is reduced while suppressing a reduction in recognition accuracy and that is optimal for the installation environment. It is also possible to suppress local solutions.

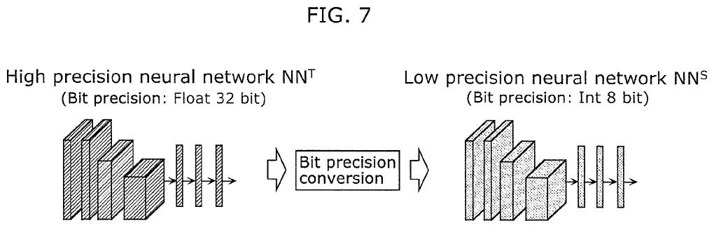

FIG. 7 is a diagram illustrating processing performed by low precision NN generator 14 according to the present embodiment.

As shown in FIG. 7, low precision NN generator 14 converts high precision neural network NN^{T} into low precision neural network NN^{S}. That is, low precision NN generator 14 generates low precision neural network NN^{S} by performing bit precision conversion, or in other words, bit reduction on each of the plurality of layers included in high precision neural network NN^{T}. For example, 32-bit float that is the bit precision of the layers included in high precision neural network NN^{T} is converted into 8-bit int. By doing so, low precision neural network NN^{S} that includes a plurality of layers that have a bit precision of 8-bit int is generated. Low precision NN generator 14 stores generated low precision neural network NN^{S} in low precision NN storage 15.

<Processing of Degree-of-Influence Deriver>

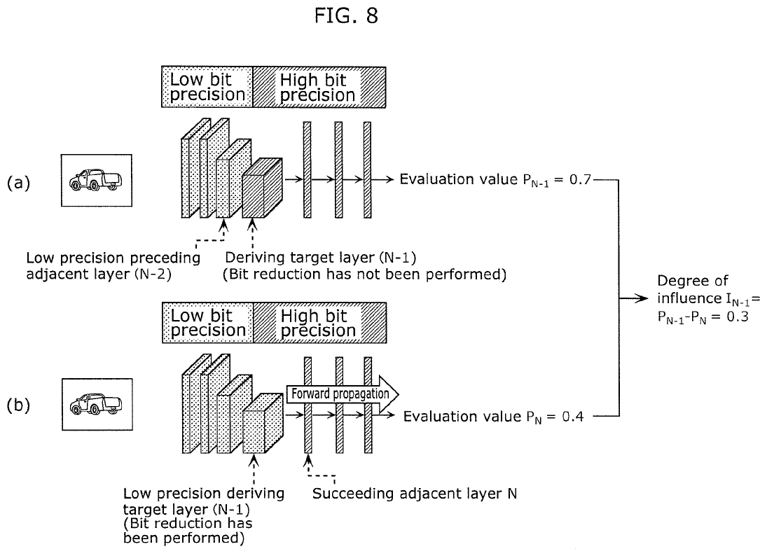

FIG. 8 is a diagram illustrating an example of processing performed by degree-of-influence deriver 16 according to the present embodiment. In FIG. 8, layers shown in a dot pattern are layers included in low precision neural network NN^{S}, and layers hatched with oblique lines are layers included in high precision neural network NN^{T}.

As described above, degree-of-influence deriver 16 derives degree of influence I of each of the plurality of preset layers included in high precision neural network NN^{T}. The plurality of preset layers are a plurality of layers that are arranged successively and serve as candidate layers for bit reduction. For example, degree-of-influence deriver 16 sequentially selects each of the plurality of preset layers as a deriving target layer, and determines, each time a deriving target layer is selected, degree of influence I of the deriving target layer.

Specifically, as shown in FIG. 8, degree-of-influence deriver 16 derives degree of influence I_{N-1} of deriving target layer (N−1) that is one of the plurality of layers included in high precision neural network NN^{T}. N is a parameter assigned to identify each of the plurality of layers included in the neural network, and is an integer of 0 or more that increments by 1 from the input layer toward the output layer. In order to derive degree of influence I_{N-1}, as shown in (a) and (b) in FIG. 8, degree-of-influence deriver 16 first derives evaluation value P_{N-1} that is a first evaluation value and evaluation value P_{N} that is a second evaluation value. Evaluation value P_{N-1} is an evaluation value based on a recognition result when bit reduction is not performed on deriving target layer (N−1). Evaluation value P_{N} is an evaluation value based on a recognition result when bit reduction is performed on deriving target layer (N−1). Then, degree-of-influence deriver 16 calculates the difference between evaluation value P_{N-1} and evaluation value P_{N} to derive degree of influence I_{N-1} of deriving target layer (N−1).

More specifically, degree-of-influence deriver 16 reads evaluation data from evaluation data storage 11, and also reads low precision neural network NN^{S} from low precision NN storage 15. Then, degree-of-influence deriver 16 acquires output data output from each of the plurality of layers included in low precision neural network NN^{S} through forward propagation of low precision neural network NN^{S} upon input of the evaluation data.

Here, high precision neural network NN^{T} includes: preceding adjacent layer (N−2) that is located adjacent to deriving target layer (N−1) on the input side; and succeeding adjacent layer N that is located adjacent to deriving target layer (N−1) on the output side. Degree-of-influence deriver 16 inputs, as preceding adjacent layer output data, the output data output from low precision preceding adjacent layer (N−2) that is one of the plurality of layers included in low precision neural network NN^{S} and corresponds to preceding adjacent layer (N−2) into deriving target layer (N−1) on which bit reduction is not performed. Then, as shown in (a) in FIG. 8, degree-of-influence deriver 16 derives evaluation value P_{N-1} based on a recognition result obtained through forward propagation of high precision neural network NN^{T} upon input of the preceding adjacent layer output data into deriving target layer (N−1).

That is, degree-of-influence deriver 16 converts the bit precision of the preceding adjacent layer output data that is output data from low precision preceding adjacent layer (N−2) into the original bit precision. For example, as shown in FIG. 7, if the bit precision of the preceding adjacent layer output data is 8-bit int, degree-of-influence deriver 16 converts the bit precision into 32-bit float. Then, degree-of-influence deriver 16 inputs the preceding adjacent layer output data whose bit precision has been converted into the original bit precision into deriving target layer (N−1) on which bit reduction is not performed. After that, degree-of-influence deriver 16 executes forward propagation on the layers ranging from deriving target layer (N−1) to the output layer in high precision neural network NN^{T}. For example, in the forward propagation, output data aT_{N-1} from deriving target layer (N−1) is calculated by using a^{T}_{N-1}=f(a^{s}_{N-2} W^{T}_{N-1}+bT_{N-1}). as_{N-2} is the output data from low precision preceding adjacent layer (N−2), or in other words, the preceding adjacent layer output data, WT_{N-1} is the weight of deriving target layer (N−1), and bT_{N-1} is the bias of deriving target layer (N−1). Based on the recognition result obtained through the forward propagation described above, evaluation value P_{N-1} is derived as a first evaluation value.

Furthermore, degree-of-influence deriver 16 inputs, as deriving target layer output data, the output data from low precision deriving target layer (N−1) that is one of the plurality of layers included in low precision neural network NN^{S} and corresponds to deriving target layer (N−1) into succeeding adjacent layer N on which bit reduction is not performed. Then, as shown in (b) in FIG. 8, degree-of-influence deriver 16 derives evaluation value P_{N} based on the recognition result obtained through forward propagation of high precision neural network NN^{T} upon input of the deriving target layer output data into succeeding adjacent layer N.

That is, degree-of-influence deriver 16 converts the bit precision of the deriving target layer output data that is the output data from low accuracy deriving target layer (N−1) into the original bit precision. For example, as shown in FIG. 7, if the bit precision of the preceding adjacent layer output data is 8-bit int, the bit precision is converted into 32-bit float. Then, degree-of-influence deriver 16 inputs the deriving target layer output data whose bit precision has been converted into the original bit precision into succeeding adjacent layer N on which bit reduction is not performed. After that, degree-of-influence deriver 16 executes forward propagation on the layers ranging from succeeding adjacent layer N to the output layer in high precision neural network NN^{T}. For example, in the forward propagation, output data aT_{N} from succeeding adjacent layer N is calculated by using aT_{N}=f(a^{s}_{N-1}W^{T}_{N}+b^{T}_{N}). a^{s}_{N-1} is the output data from low precision deriving target layer (N−1), or in other words, the deriving target layer output data, W^{T}_{N} is the weight of succeeding adjacent layer N, and b^{T}_{N} is the bias of succeeding adjacent layer N. Based on the recognition result obtained through the forward propagation described above, evaluation value P_{N} is derived as a second evaluation value.

When evaluation value P_{N-1} and evaluation value P_{N} have been derived in the manner described above, degree-of-influence deriver 16 calculates degree of influence I_{N-1} of deriving target layer (N−1) by using I_{N-1}=P_{N-1}−P_{N}. For example, as shown in FIG. 8, if P_{N}-1=0.7 and P_{N}=0.4, degree-of-influence deriver 16 calculates degree of influence I_{N-1} of deriving target layer (N−1) to be 0.3.

As described above, in the present embodiment, the degree of influence of the deriving target layer is derived in the case where the bit precision of each of the layers from the input layer to the preceding adjacent layer included in high precision neural network NN^{T} is low, and the bit precision of each of the layers from the succeeding adjacent layer to the output layer included in high precision neural network NN^{T} is high. That is, in this case, the difference between the first evaluation value obtained when bit reduction is not performed on the deriving target layer and the second evaluation value obtained when bit reduction is performed on the deriving target layer is derived as the degree of influence of the deriving target layer. Accordingly, the degree of influence exerted on the recognition result of high precision neural network NN^{T} can be derived more significantly and more appropriately according to whether or not bit reduction is performed on the deriving target layer. As a result, it is possible to more appropriately find out an optimum solution for the neural network.

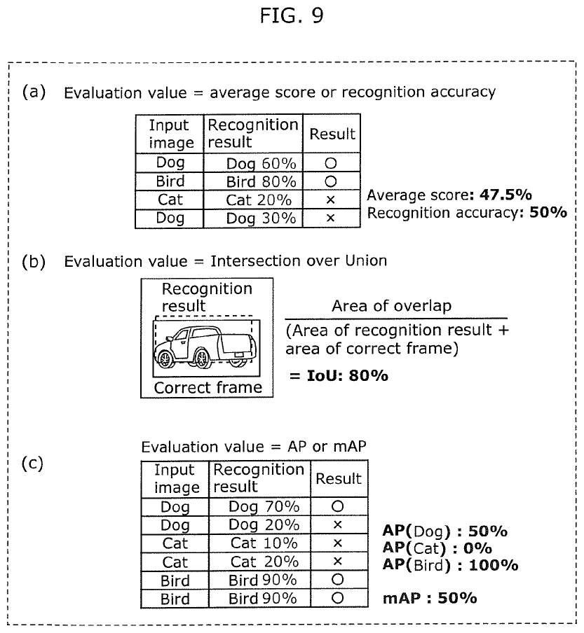

FIG. 9 is a diagram showing an example of evaluation values according to the present embodiment.

For example, as shown in (a) in FIG. 9, as the evaluation value, the average score or recognition accuracy obtained as recognition results from the neural network may be used. As a specific example, an input image in which a dog is reflected is input as evaluation data into the neural network, and “60%” is output from the neural network as the recognition result of the dog. Likewise, “80%” is output as the recognition result of a bird, “20%” is output as the recognition result of a cat, and “30%” is output as the recognition result of another dog from the neural network. In this case, the average score that is the average value of the recognition results is 47.5%. Also, if the threshold value of the recognition results is, for example, 50%, the dog and the cat are correctly recognized, but the bird and the other dog are incorrectly recognized. Accordingly, the recognition accuracy that is the proportion of the number of times of correct recognition to the total number of times of recognition is 50%. Accordingly, as the evaluation value, an average score of “47.5%” may be used, or a recognition accuracy of “50%” may be used.

Alternatively, as shown in (b) in FIG. 9, as the evaluation value, intersection over union (also referred to as IoU) between frames obtained from the recognition result of the neural network may be used. As a specific example, an input image in which an object such as a car is reflected is input as evaluation data into the neural network, and a frame in which the object is reflected is output as a recognition result from the neural network. The intersection over union between frames is the ratio of the area of overlap to the sum of a recognition result area and a correct frame area. The recognition result area is the area of a region surrounded by the frame output as the recognition result, and the correct frame area is the area of a region surrounded by a correct frame. Then, the area of overlap is the area of an overlapping portion of these regions.

Alternatively, as shown in (c) in FIG. 9, as the evaluation value, AP (Average Precision) or mAP (mean Average Precision) obtained from the recognition result from the neural network may be used. As a specific example, an input image in which a dog is reflected is input as evaluation data into the neural network, and “70%” is output from the neural network as the recognition result of the dog. If the threshold value of the recognition result is, for example, 50%, the dog is correctly recognized. On the other hand, an input image in which another dog is reflected is input as evaluation data into the neural network, and “20%” is output from the neural network as the recognition result of the other dog. If the threshold value of the recognition result is, for example, 50%, the other dog is incorrectly recognized. In this case, AP that is the proportion of the number of times of correct recognition to the total number of times of recognition of the dog is 50%. Likewise, AP that is the proportion of the number of times of correct recognition to the total number of times of recognition of the cat is 0%, and AP that is the proportion of the number of times of correct recognition to the total number of times of recognition of the bird is 100%. In this case, mAP that is the average of the APs is 50%. As described above, AP is recognition accuracy relative to an object (or in other words, class) of the same type, and mAP is the average of a plurality of APs.

As described above, the evaluation value is a value derived based on the recognition result output from the neural network upon input of each of a plurality of evaluation data into the neural network.

As the recognition result obtained from the neural network of the present embodiment, for example, recognition accuracy or score is used, but the recognition result obtained from the neural network of the present embodiment is not limited thereto. For example, as the recognition result, recognition score and object position (or in other words, position in a two-dimensional coordinate system in input image) may be used. Also, in the case where the neural network converts input data and outputs converted data, the converted data may be used as the recognition result. The converted data may be, specifically, data obtained by removing noise from input data, or may be data obtained by super-resolving input data. Also, in the case where the neural network predicts (returns) a future state of an object, the predicted future state of the object may be used as the recognition result.

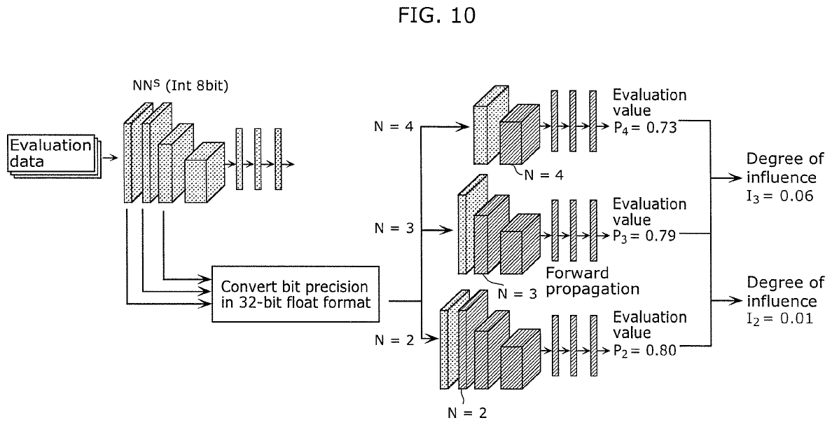

FIG. 10 is a diagram illustrating a specific example of processing performed by degree-of-influence deriver 16 according to the present embodiment.

Degree-of-influence deriver 16 inputs each of the plurality of evaluation data stored in low precision NN storage 15 into low precision neural network NN^{S}. Then, degree-of-influence deriver 16 acquires, each time evaluation data is input, output data output from each of the plurality of layers included in low precision neural network NN^{S} through forward propagation of low precision neural network NN^{S} upon input of the evaluation data. Furthermore, degree-of-influence deriver 16 converts the bit precision of these output data into the original bit precision. For example, if the bit precision of these output data is 8-bit int, degree-of-influence deriver 16 converts the bit precision into 32-bit float. That is, the values represented in 8-bit int format by the output data are represented in 32-bit float format.

Then, degree-of-influence deriver 16 inputs the plurality of output data output from the layer represented by N=1 included in low precision neural network NN^{S} into the layer represented by N=2 included in high precision neural network NN^{T}. The bit precision of these output data is converted to the same bit precision as that of the layer represented by N=2 included in high precision neural network NN^{T}. Then, degree-of-influence deriver 16 executes forward propagation on the layers ranging from the layer represented by N=2 to the output layer included in high precision neural network NN^{T} to the output layer each time output data is input to derive, for example, P₂=0.80 as the evaluation value for N=2.

Likewise, degree-of-influence deriver 16 inputs the plurality of output data output from the layer represented by N=2 included in low precision neural network NN^{S} into the layer represented by N=3 included in high precision neural network NN^{T}. The bit precision of these output data is converted to the same bit precision as that of the layer represented by N=3 included in high precision neural network NN^{T}. Then, degree-of-influence deriver 16 executes forward propagation on the layers ranging from the layer represented by N=3 to the output layer included in high precision neural network NN^{T} to the output layer each time output data is input to derive, for example, P₃=0.79 as the evaluation value for N=3.

Likewise, degree-of-influence deriver 16 inputs the plurality of output data output from the layer represented by N=3 included in low precision neural network NN^{S} into the layer represented by N=4 included in high precision neural network NN^{T}. The bit precision of these output data is converted to the same bit precision as that of the layer represented by N=4 included in high precision neural network NN^{T}. Then, degree-of-influence deriver 16 executes forward propagation on the layers ranging from the layer represented by N=4 to the output layer included in high precision neural network NN^{T} to the output layer each time output data is input to derive, for example, P₄=0.73 as the evaluation value for N=4.

Based on these evaluation values, degree-of-influence deriver 16 calculates I₂=P₂−P₃=0.01 as the degree of influence of the layer represented by N=2 included in high precision neural network NN^{T}. Furthermore, degree-of-influence deriver 16 calculates I₃=P₃−P₄=0.06 as the degree of influence of the layer represented by N=3 included in high precision neural network NN^{T}.

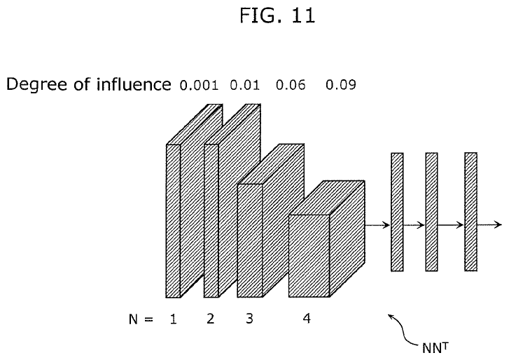

FIG. 11 is a diagram showing an example of the degree of influence derived by degree-of-influence deriver 16 according to the present embodiment.

For example, as shown in FIG. 11, the degree of influence is calculated for each of the plurality of preset layers included in high precision neural network NN^{T}. Specifically, the degree of influence of the layer represented by N=1 is calculated to be 0.001, the degree of influence of the layer represented by N=2 is calculated to be 0.01, the degree of influence of the layer represented by N=3 is calculated to be 0.06, and the degree of influence of the layer represented by N=4 is calculated to be 0.09.

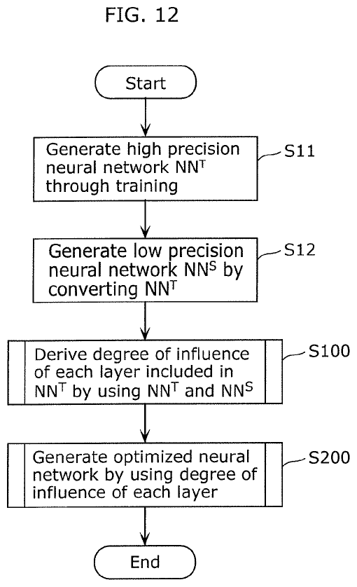

FIG. 12 is a flowchart illustrating an example of overall processing performed by neural network optimization device 10 according to the present embodiment.

First, high precision NN generator 12 of neural network optimization device 10 performs training using the plurality of evaluation data stored in evaluation data storage 11 to generate high precision neural network NN^{T} (step S11).

Next, low precision NN generator 14 converts the bit precision of high precision neural network NN^{T} generated in step S11 to generate low precision neural network NN^{S} (step S12).

Then, degree-of-influence deriver 16 derives the degree of influence of each of the plurality of preset layers included in high precision neural network NN^{T} by using high precision neural network NN^{T} generated in step S11 and low precision neural network NN^{S} (step S100).

Next, bit reduction layer identifier 17 generates an optimized neural network by using the degree of influence of each of the plurality of layers derived in step S100 (step S200).

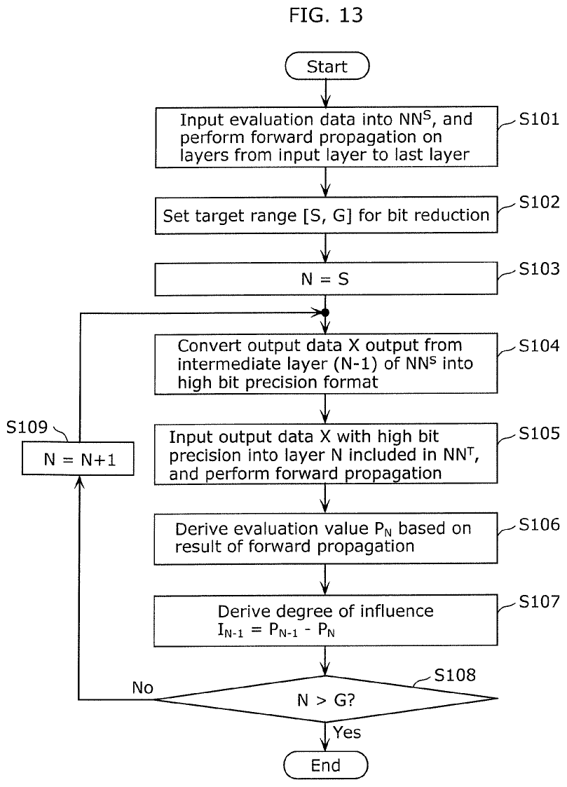

FIG. 13 is a flowchart illustrating an example of processing performed by degree-of-influence deriver 16 according to the present embodiment. Specifically, FIG. 13 is a flowchart illustrating in detail the processing in step S100 shown in FIG. 12.

First, degree-of-influence deriver 16 inputs each of a plurality of evaluation data into low precision neural network NN^{S}, and executes, for each of the plurality of evaluation data, forward propagation on the layers ranging from the input layer to the last layer (or in other words, the output layer) included in low precision neural network NN^{S} (step S101). Output data from each layer through the forward propagation is stored.

Next, degree-of-influence deriver 16 sets target range [S, G] for bit reduction from all of the layers included in high precision neural network NN^{T} (step S102). S and G are integers of 0 or more, and G is greater than S. That is, the target range for bit reduction ranges from the layer represented by N=S (or in other words, layer (N=S)) to the layer represented by N=G (or in other words, layer (N=G)) among all of the layers described above. To rephrase, the layers included in the target range are candidate layers for bit reduction. Also, the plurality of preset layers described above are a plurality of layers included in the range ranting from layer (N=S) to layer (N=G). Target range [S, G] may include all of the layers included in high precision neural network NN^{T}.

Next, degree-of-influence deriver 16 sets parameter N to N=S (step S103). That is, degree-of-influence deriver 16 initializes parameter N. Then, degree-of-influence deriver 16 converts the bit precision of output data X output from intermediate layer (N−1) of low precision neural network NN^{S} into a high bit precision (step S104). That is, the bit precision of output data X is converted into the original bit precision.

Next, degree-of-influence deriver 16 inputs output data X whose bit precision was converted in step S104 into layer N in high precision neural network NN^{T}, and performs forward propagation on the layers ranging from layer N to the output layer (step S105). Then, degree-of-influence deriver 16 derives evaluation value P_{N} based on the result of forward propagation (step S106). The processing in steps S104 and S105 is performed for each of the plurality of evaluation data, or in other words, for each of the plurality of output data. Accordingly, in step S106, evaluation value P_{N} is derived based on the evaluation result that is the result of forward propagation obtained from each of the plurality of evaluation data.

Next, degree-of-influence deriver 16 calculates degree of influence I_{N-1} of layer (N−1) based on IN-1=P_{N-1}−P_{N} by using evaluation value P_{N} derived in step S106 (step S107). Here, if N=S, evaluation value P_{S-1} is not calculated, and thus degree of influence I_{S-1} of layer (S−1) is not calculated, and the processing in step S107 is skipped.

Then, degree-of-influence deriver 16 determines whether or not N is greater than G (step S108). If it is determined that N is not greater than G (No in step S108), degree-of-influence deriver 16 increments N (step S109). On the other hand, if it is determined that N is greater than G (Yes in step S108), degree-of-influence deriver 16 ends the processing of deriving the degree of influence.

<Processing of Bit Reduction Layer Identifier>

Bit reduction layer identifier 17 according to the present embodiment identifies a layer to be subjected to bit reduction from high precision neural network NN^{T} by using the degree of influence of each of the plurality of layers derived by degree-of-influence deriver 16 in the manner described above. Then, bit reduction layer identifier 17 generates a bit reduction neural network by performing bit reduction on the identified layer. Also, bit reduction layer identifier 17 evaluates the bit reduction neural network. As a result, bit reduction layer identifier 17 treats the bit reduction neural network as new high precision neural network NN^{T} unless the bit reduction neural network is an optimized neural network. Then, bit reduction layer identifier 17 repeats the processing of generating a bit reduction neural network from new high precision neural network NN^{T} by using the degree of influence described above. As a result, an optimized neural network is generated.

Here, bit reduction layer identifier 17 generates an optimized neural network by performing any one of three mutually different identification processing operations. The three identification processing operations include threshold value utilization identification processing, minimum-degree-of-influence identification processing, and degree-of-influence update identification processing.

[Threshold Utilization Identification Processing]

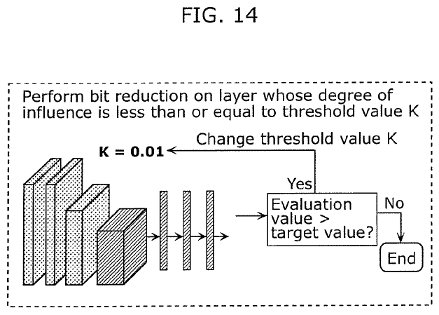

FIG. 14 is a diagram schematically showing an example of threshold value utilization identification processing performed by bit reduction layer identifier 17.

Bit reduction layer identifier 17 identifies at least one layer whose degree of influence is less than or equal to threshold value K from among the plurality of layers included in target range [S, G] of high precision neural network NN^{T}, and performs bit reduction on the at least one layer identified. As a result, a bit reduction neural network is generated. Then, bit reduction layer identifier 17 derives an evaluation value of the bit reduction neural network by using the evaluation data stored in evaluation data storage 11, and determines whether or not the evaluation value is greater than the target value. If it is determined that the evaluation value is greater than the target value, bit reduction layer identifier 17 treats the bit reduction neural network as new high precision neural network NN^{T}, and changes threshold value K. Specifically, threshold value K is changed to a greater value. Then, bit reduction layer identifier 17 repeats generation of a bit reduction neural network by using new high precision neural network NN^{T} and changed threshold value K. As a result, an optimized neural network is generated.

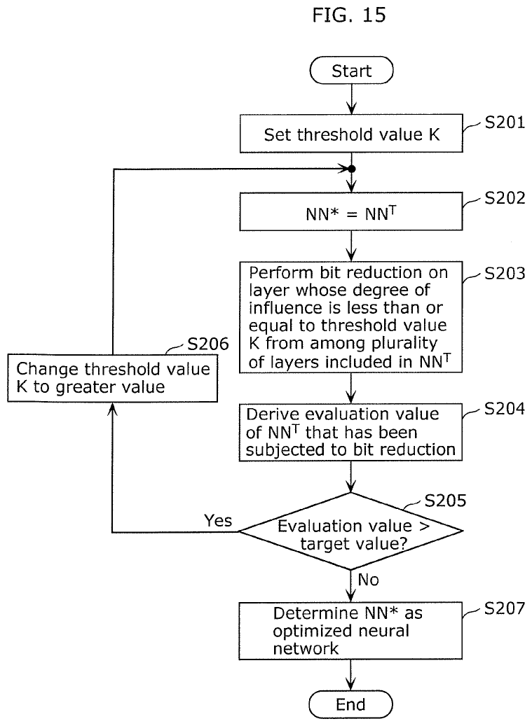

FIG. 15 is a flowchart illustrating an example of threshold value utilization identification processing performed by bit reduction layer identifier 17.

Bit reduction layer identifier 17 first sets threshold value K (step S201), and stores high precision neural network NN^{T} as neural network NN* that is immediately before bit reduction is performed (step S202).

Next, bit reduction layer identifier 17 identifies a layer whose degree of influence is less than or equal to threshold value K from among target range [S, G] of high precision neural network NN^{T}, and performs bit reduction on the identified layer (step S203). If a plurality of layers are identified, bit reduction is performed on each of the plurality of layers. By doing so, a bit reduction neural network is generated. That is, the second processing described above is performed. Then, bit reduction layer identifier 17 derives an evaluation value of the bit reduction neural network, or in other words, high precision neural network NN^{T} that has been subjected to bit reduction (step S204).

Next, bit reduction layer identifier 17 determines whether or not the evaluation value derived in step S204 is greater than the target value (step S205). If it is determined that the evaluation value determined in step S204 is greater than the target value (Yes in step S205), bit reduction layer identifier 17 changes threshold value K to a greater value (step S206). Then, bit reduction layer identifier 17 treats the bit reduction neural network as new high precision neural network NN^{T}, and repeatedly executes the processing from step S202. Accordingly, in step S202, the bit reduction neural network, namely, new high precision neural network NN^{T} is stored as neural network NN* that is immediately before bit reduction is performed in step S203 performed next.

On the other hand, if it is determined in step S205 that the evaluation value is less than the target value (No in step S205), bit reduction layer identifier 17 determines an optimized neural network (step S207). That is, neural network NN* stored in step S202, that is, the neural network immediately before bit reduction is performed last is determined as the optimized neural network. If it is determined in step S205 that the evaluation value is equal to the target value, bit reduction layer identifier 17 determines the bit reduction neural network generated in step S203 performed immediately before as an optimized neural network.

As described above, bit reduction layer identifier 17 according to the present embodiment performs third processing as the processing in step S204. In the third processing, bit reduction layer identifier 17 derives a third evaluation value that is an evaluation value based on a recognition result output upon input of the evaluation data into the bit reduction neural network, the third evaluation value increasing with an increase in object recognition accuracy. Then, if the third evaluation value is greater than the target value as in step S206, bit reduction layer identifier 17 performs fourth processing of updating threshold value K by increasing threshold value K. After that, bit reduction layer identifier 17 repeatedly executes the second processing, the third processing, and the fourth processing by using the bit reduction neural network as new high precision neural network NN^{T} and also using updated threshold value K. In the second processing that is repeatedly executed, bit reduction layer identifier 17 identifies at least one layer whose degree of influence is less than or equal to updated threshold value K from among at least one the plurality of layers in target range [S, G] of new high precision neural network NN^{T}, the at least one of the plurality of layers not being subjected to bit reduction yet.

Also, when the second processing and the third processing are repeatedly executed, and the third evaluation value derived in the third processing executed last is less than the target value, bit reduction layer identifier 17 outputs the bit reduction neural network generated in the second processing executed immediately before the last second processing is performed as the final neural network. That is, neural network NN* stored in step S202 is determined as the final neural network, or in other words, as the optimized neural network.

As described above, in the threshold value utilization identification processing, as long as the evaluation value derived in step S204 is greater than the target value, the threshold value is updated, and bit reduction is repeated. Accordingly, it is possible to appropriately find out a neural network that does not have recognition accuracy that is more than necessary. Furthermore, even if the evaluation value of the bit reduction neural network generated in the processing in last step S203 is less than the target value, the evaluation value of the bit reduction neural network generated in the processing in step S203 performed immediately before last step S203 is performed is greater than the target value. The bit reduction neural network from which the evaluation value that is greater than the target value is derived is output as the final neural network, and thus it is possible to more appropriately find out a neural network in which the amount of data is sufficiently reduced while keeping the recognition accuracy at a certain level.

[Minimum-Degree-of-Influence Identification Processing]

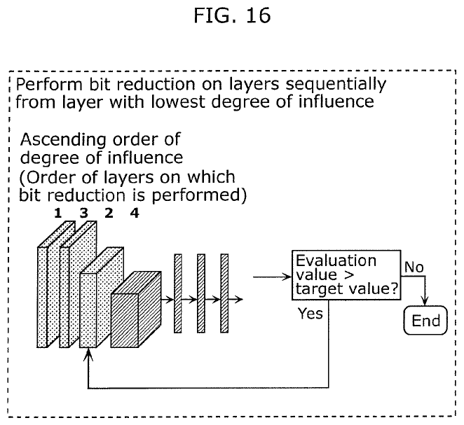

FIG. 16 is a diagram schematically showing an example of minimum-degree-of-influence identification processing performed by bit reduction layer identifier 17.

Bit reduction layer identifier 17 identifies one layer whose degree of influence is lowest from among the plurality of layers included in target range [S, G] of high precision neural network NN^{T}, and performs bit reduction on the one layer identified. As a result, a bit reduction neural network is generated. Then, bit reduction layer identifier 17 derives an evaluation value of the bit reduction neural network by using the evaluation data stored in evaluation data storage 11, and then determines whether or not the evaluation value is greater than the target value. As a result, if it is determined that the evaluation value is greater than the target value, bit reduction layer identifier 17 treats the bit reduction neural network as new high precision neural network NN^{T}. Then, bit reduction layer identifier 17 repeats generation of a bit reduction neural network from new high precision neural network NN^{T}. That is, a bit reduction neural network is repeatedly generated as a result of bit reduction being performed on one layer whose degree of influence is lowest from among at least one of the layers included in new high precision neural network NN^{T} that is not subjected to bit reduction yet. That is, bit reduction is performed on the layers sequentially from the layer with the lowest degree of influence. As a result, an optimized neural network is generated.

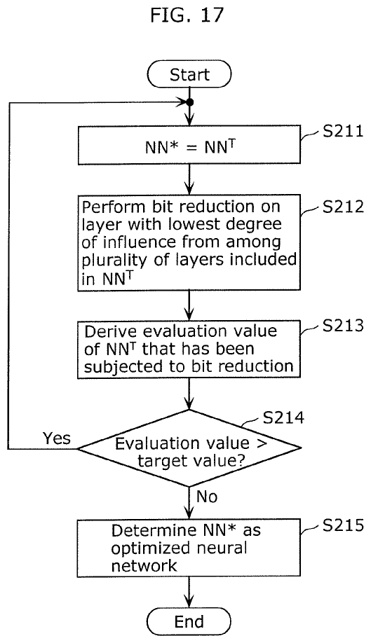

FIG. 17 is a flowchart illustrating an example of minimum-degree-of-influence identification processing performed by bit reduction layer identifier 17.

Bit reduction layer identifier 17 first stores high precision neural network NN^{T} as neural network NN* that is immediately before bit reduction is performed (step S211).

Next, bit reduction layer identifier 17 identifies a layer whose degree of influence is lowest from target range [S, G] of high precision neural network NN^{T}, and performs bit reduction on the identified layer (step S212). By doing so, a bit reduction neural network is generated. That is, the second processing described above is performed. Then, bit reduction layer identifier 17 derives an evaluation value of the bit reduction neural network, or in other words, high precision neural network NN^{T} that has been subjected to bit reduction (step S213).

Next, bit reduction layer identifier 17 determines whether or not the evaluation value derived in step S213 is greater than the target value (step S214). Here, if it is determined that the evaluation value is greater than the target value, (Yes in step S214), bit reduction layer identifier 17 treats the bit reduction neural network as new high precision neural network NN^{T}, and repeatedly executes the processing from step S211. Accordingly, in step S211, the bit reduction neural network, namely, new high precision neural network NN^{T} is stored as neural network NN* that is immediately before bit reduction is performed in step S212 performed next.

On the other hand, if it is determined in step S214 that the evaluation value is less than the target value (No in step S214), bit reduction layer identifier 17 determines an optimized neural network (step S215). That is, neural network NN* stored in step S211, that is, the neural network immediately before bit reduction is performed last is determined as the optimized neural network. If it is determined in step S214 that the evaluation value is equal to the target value, bit reduction layer identifier 17 determines the bit reduction neural network generated in step S212 performed immediately before as an optimized neural network.

As described above, bit reduction layer identifier 17 according to the present embodiment performs third processing as the processing in step S213. In the third processing, bit reduction layer identifier 17 derives a third evaluation value that is an evaluation value based on a recognition result output upon input of the evaluation data into the bit reduction neural network, the third evaluation value increasing with an increase in recognition accuracy of the object. Then, if the third evaluation value is greater than the target value, bit reduction layer identifier 17 repeatedly executes the second processing and the third processing by using the bit reduction neural network as new high precision neural network NN^{T}. Also, in the second processing that is repeatedly executed, bit reduction layer identifier 17 identifies one layer whose degree of influence is lowest from among at least one of the plurality of layers in target range [S, G] of new high precision neural network NN^{T}, the at least one of the plurality of layers not being subjected to bit reduction yet.

Also, when the second processing and the third processing are repeatedly executed, and the third evaluation value derived in the third processing executed last is less than the target value, bit reduction layer identifier 17 outputs the bit reduction neural network generated in the second processing executed immediately before the last second processing is performed as the final neural network. That is, neural network NN* stored in step S202 is determined as the final neural network, or in other words, as the optimized neural network.

As described above, in the minimum-degree-of-influence identification processing, as long as the evaluation value derived in step S212 is greater than the target value, bit reduction is performed on the plurality of layers sequentially from the layer with the lowest degree of influence. Accordingly, it is possible to appropriately find out a neural network that does not have recognition accuracy that is more than necessary. Furthermore, even if the evaluation value of the bit reduction neural network generated in the processing in step S212 performed last is less than the target value, the evaluation value of the bit reduction neural network generated in the processing in step S212 performed immediately before last step S212 is greater than the target value. Because the bit reduction neural network from which the evaluation value that is greater than the target value is derived is output as the final neural network, and thus it is possible to more appropriately find out a neural network in which the amount of data is sufficiently reduced while keeping the recognition accuracy at a certain level.

[Degree-of-Influence Update Identification Processing]

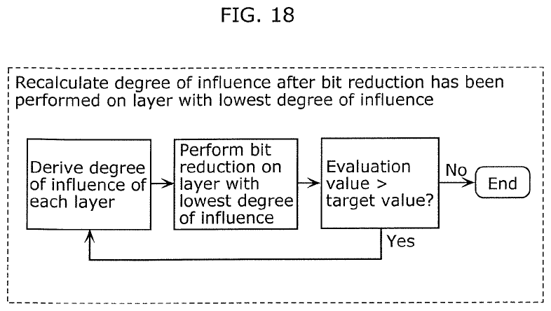

FIG. 18 is a diagram schematically showing an example of degree-of-influence update identification processing performed by bit reduction layer identifier 17.

In the case of generating an optimized neural network by using degree-of-influence update identification processing, bit reduction layer identifier 17 utilizes the result of processing performed by each of low precision NN generator 14 and degree-of-influence deriver 16. For example, as described above, for each of the plurality of layers included in target range [S, G] of high precision neural network NN^{T}, the degree of influence is derived by degree-of-influence deriver 16. Bit reduction layer identifier 17 identifies one layer whose degree of influence is lowest from among the plurality of layers, and performs bit reduction on the one layer identified. As a result, a bit reduction neural network is generated. Then, bit reduction layer identifier 17 derives an evaluation value of the bit reduction neural network by using the evaluation data stored in evaluation data storage 11, and then determines whether or not the evaluation value is greater than the target value. As a result, if it is determined that the evaluation value is greater than the target value, bit reduction layer identifier 17 outputs the bit reduction neural network to low precision NN generator 14 as new high precision neural network NN^{T}. By doing so, generation of low precision neural network NN^{S} by low NN precision generator 14 and deriving of the degree of influence for each of the plurality of layers using low precision neural network NN^{S} by degree-of-influence deriver 16 are repeatedly executed. As a result, generation of a bit reduction neural network is repeatedly executed, and an optimized neural network is generated.

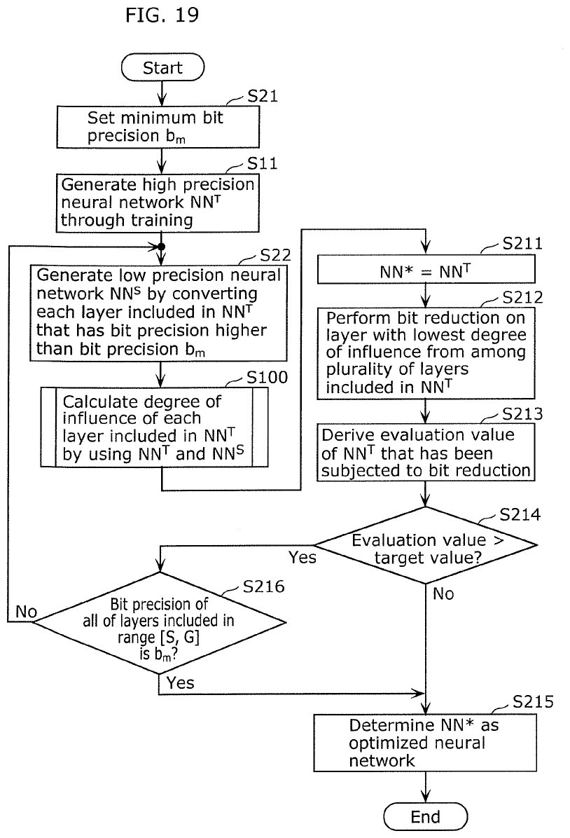

FIG. 19 is a flowchart illustrating another example of overall processing performed by neural network optimization device 10 according to the present embodiment. The flowchart includes steps S22, S100, and S211 to S216 as the degree-of-influence update identification processing performed by bit reduction layer identifier 17.

First, low precision NN generator 14 sets minimum bit precision bₘ (step S21). Then, high precision NN generator 12 generates high precision neural network NN^{T} by performing training using the plurality of evaluation data stored in evaluation data storage 11 (step S11).

Next, low precision NN generator 14 generates low precision neural network NN^{S} by converting the bit precision of high precision neural network NN^{T} generated in step S11 (step S22). At this time, low precision NN generator 14 converts a bit precision that is higher than minimum bit precision bₘ set in step S21 among the bit precisions of the plurality of layers included in high precision neural network NN^{T}. That is, low precision NN generator 14 performs bit reduction on a layer that has a bit precision higher than minimum bit precision bₘ. Accordingly, if all of the layers included in high precision neural network NN^{T} have a bit precision higher than minimum bit precision bₘ, low precision NN generator 14 performs the same processing as that in step S12 shown in FIG. 12.

Then, degree-of-influence deriver 16 derives the degree of influence for each of the plurality of layers by using high precision neural network NN^{T} generated in step S11 and low precision neural network NN^{S} generated in step S22 (step S100). That is, degree-of-influence deriver 16 derives the degree of influence of each of the plurality of layers included in target range [S, G] of high precision neural network NN^{T}. The processing that includes steps S22 and S100 corresponds to the first processing described above.

Next, bit reduction layer identifier 17 performs the processing in steps S211 to S214, as in the flowchart shown in FIG. 17. That is, bit reduction layer identifier 17 identifies a layer whose degree of influence is lowest from target range [S, G] of high precision neural network NN^{T}, and performs bit reduction on the identified layer (step S212). By doing so, a bit reduction neural network is generated. That is, the second processing described above is performed. Then, bit reduction layer identifier 17 derives an evaluation value of the bit reduction neural network, or in other words, high precision neural network NN^{T} that has been subjected to bit reduction (step S213). Next, bit reduction layer identifier 17 determines whether or not the evaluation value derived in step S213 is greater than the target value (step S214).

Here, if it is determined that the evaluation value is greater than the target value (Yes in step S214), low precision NN generator 14 determines whether or not the bit precision of all of the layers included in target range [S, G] is minimum bit precision bₘ (step S216). That is, it is determined whether or not the bit precision of all of the layers included in target range [S, G] of the bit reduction neural network generated in step S212 is minimum bit precision bₘ. Then, if it is determined that the bit precision of all of the layers is not minimum bit precision bₘ (No in step S216), low precision NN generator 14 repeatedly executes the processing from step S22. If the processing from step S22 is repeatedly executed, the bit reduction neural network generated in step S212 performed immediately before is treated as new high precision neural network NN^{T}.

On the other hand, if it is determined in step S214 that the evaluation value is less than the target value (No in step S214), bit reduction layer identifier 17 determines an optimized neural network (step S215). That is, neural network NN* stored in step S211, that is, the neural network immediately before bit reduction is performed last is determined as the optimized neural network.

If it is determined in step S216 that the bit precision of all of the layers is minimum bit precision bₘ (Yes in step S216), bit reduction layer identifier 17 determines an optimized neural network in the same manner as described above (step S215). Also, in this case, bit reduction layer identifier 17 may determine the bit reduction neural network generated in step S212 performed immediately before, as the optimized neural network.

As described above, bit reduction layer identifier 17 according to the present embodiment identifies one layer whose degree of influence is lowest from among the plurality of layers included in target range [S, G] of high precision neural network NN^{T} as in step S212, and performs bit reduction on the one layer identified. Furthermore, bit reduction layer identifier 17 performs third processing as the processing in step S213. In the third processing, bit reduction layer identifier 17 derives a third evaluation value that is an evaluation value based on a recognition result output upon input of the evaluation data into the bit reduction neural network, the third evaluation value increasing with an increase in object recognition accuracy. Then, if the third evaluation value is greater than the target value, bit reduction layer identifier 17 repeatedly executes the first processing, the second processing, and the third processing by using the bit reduction neural network as new high precision neural network NN^{T}. The first processing corresponds to the processing that includes steps S22 and S100, the second processing corresponds to the processing in step S212, and the third processing corresponds to the processing in step S213.

Also, when the second processing and the third processing are repeatedly executed, and the third evaluation value derived in the third processing executed last is less than the target value, bit reduction layer identifier 17 outputs the bit reduction neural network generated in the second processing executed immediately before the last second processing as the final neural network. That is, neural network NN* stored in step S202 is determined as the final neural network, or in other words, as the optimized neural network.

As described above, in the degree-of-influence update identification processing, the bit reduction neural network is treated as new high precision neural network NN^{T}, and the degree of influence is derived for each of the plurality of layers included in new high precision neural network NN^{T}. Then, using the degrees of influence, a layer to be subjected to bit reduction is identified from among the plurality of layers included in new high precision neural network NN^{T}. Accordingly, appropriate degrees of influence can be used for new high precision neural network NN^{T} without using old degrees of influence derived for original high precision neural network NN^{T}. As a result, it is possible to more appropriately find out an optimum solution for the neural network. Furthermore, even if the evaluation value of the bit reduction neural network generated in the processing in last step S212 is less than the target value, the evaluation value of the bit reduction neural network generated in the processing is step S212 performed immediately before last step S212 is greater than the target value. The bit reduction neural network from which the evaluation value that is greater than the target value is derived is output as the final neural network, and thus it is possible to more appropriately find out a neural network in which the amount of data is sufficiently reduced while keeping the recognition accuracy at a certain level.

(Variations)

Up to here, the neural network optimization device according to one or more aspects has been described by way of an embodiment, but the present disclosure is not limited to the embodiment. Other embodiments obtained by making various modifications that can be conceived by a person having ordinary skill in the art to the above embodiment as well as embodiments implemented by combining other structural elements without departing from the scope of the present disclosure may also be encompassed in the scope of the present disclosure.

For example, as shown in FIG. 8 or the like, degree-of-influence deriver 16 according to the embodiment described above derives the degree of influence of the deriving target layer in the case where the layers from the input layer to the preceding adjacent layer included in high precision neural network NN^{T} have a low bit precision, and the layers from the succeeding adjacent layer to the output layer included in high precision neural network NN^{T} have a high bit precision. However, conversely, degree-of-influence deriver 16 may derive the degree of influence of the deriving target layer in the case where the layers from the input layer to the preceding adjacent layer included in high precision neural network NN^{T} have a high bit precision, and the layers from the succeeding adjacent layer to the output layer included in high precision neural network NN^{T} have a low bit precision. Alternatively, degree-of-influence deriver 16 may derive the degree of influence of the deriving target layer in the case where the layers from the input layer to the preceding adjacent layer included in high precision neural network NN^{T} and the layers from the succeeding adjacent layer to the output layer included in high precision neural network NN^{T} have a high bit precision. That is, degree-of-influence deriver 16 may derive, as the degree of influence of the deriving target layer, the difference between an evaluation value obtained when bit reduction is performed only on the deriving target layer from among the layers included in high precision neural network NN^{T} and an evaluation value obtained when bit reduction is not performed on any of the layers.

Also, in step S203 of FIG. 15 and step S212 of FIG. 17, bit reduction layer identifier 17 according to the embodiment given above does not perform additional bit reduction on the layer that has already been subjected to bit reduction. However, if bit reduction has already been performed on all of the layers, bit reduction layer identifier 17 may further identify a layer to be subjected to bit reduction based on the degrees of influence of the layers, and reduce the bit precision of the identified layer.

Also, the neural network according to the embodiment given above may be a convolutional neural network, or any other type of neural network. Also, the training according to the embodiment given above may be any training as long as it is machine learning, and may be, for example, deep learning. Also, in the embodiment given above, the bit precision of parameters that constitute a layer is reduced, but the parameters may include, not only weight and bias, but also output data. In addition, the bit precision of at least one of weight, bias, and output data may be reduced.

Also, neural network optimization device 10 according to the embodiment given above includes high precision NN generator 12, but does not necessarily include high precision NN generator 12. In this case, neural network optimization device 10 may acquire high precision neural network NN^{T} from, for example, another device such as a server via a communication network, or from a recording medium such as a memory that is connected to neural network optimization device 10. Also, neural network optimization device 10 includes storages such as evaluation data storage 11, high precision NN storage 13, and low precision NN storage 15, but does not necessarily include these storages. In this case, neural network optimization device 10 may use external recording media or the like instead of these storages.

In the embodiment given above, the structural elements may be configured using dedicated hardware or may be implemented by executing a software program suitable for each structural element. Each structural element may be implemented as a result of a program executor such as a CPU (Central Processing Unit) or a processor reading a software program recorded on a recording medium such as a hard disk or a semiconductor memory and executing the software program. Here, a software program that implements the neural network optimization device and the like of the embodiment given above causes a computer to execute processing shown in at least one of the flowcharts shown in FIGS. 12, 13, 15, 17, and 19.

The following configurations are also encompassed by the present disclosure.

(1) At least one device described above is, specifically, a computer system that includes a microprocessor, a ROM (Read Only Memory), a RAM (Random Access Memory), a hard disk unit, a display unit, a keyboard, a mouse, and the like. A computer program is stored in the RAM or the hard disk unit. The functions of the at least one device described above are implemented as a result of the microprocessor operating in accordance with the computer program. Here, the computer program is composed of a combination of a plurality of instruction codes that indicate instructions for the computer to achieve predetermined functions.

(2) Some or all of the structural elements that constitute at least one device described above may be composed of a single system LSI (Large Scale Integration). The system LSI is a super multifunctional LSI manufactured by integrating a plurality of structural elements on a single chip, and is specifically a computer system that includes a microprocessor, a ROM, a RAM, and the like. A computer program is stored in the RAM. The functions of the system LSI are implemented as a result of the microprocessor operating in accordance with the computer program.

(3) Some or all of the structural elements that constitute at least one device described above may be composed of an IC card or a single module that can be attached and detached to and from the device. The IC card or the module is a computer system that includes a microprocessor, a ROM, a RAM, and the like. The IC card or the module may include the above-described super multifunctional LSI. The functions of the IC card or the module are implemented as a result of the microprocessor operating in accordance with a computer program. The IC card or the module may have tamper resistance.

(4) The present disclosure may be any of the methods described above. Alternatively, the present disclosure may be a computer program that implements the methods by using a computer, or may be a digital signal generated by the computer program.

Alternatively, the present disclosure may be recorded on a computer readable recording medium that can read the computer program or the digital signal such as, for example, a flexible disk, a hard disk, a CD (Compact Disc)-ROM, a DVD, a DVD-ROM, a DVD-RAM, a BD (Blu-ray (registered trademark) Disc), or a semiconductor memory. Also, the present disclosure may be the digital signal recorded in the recording medium.

Alternatively, the present disclosure may transmit the computer program or the digital signal via a telecommunication line, a wireless or wired communication line, a network as typified by the Internet, data broadcasting, or the like.

Alternatively, the present disclosure may be implemented by an independent computer system by transferring the program or the digital signal recorded on a recording medium, or by transferring the program or the digital signal via a network or the like.

While various embodiments have been described herein above, it is to be appreciated that various changes in form and detail may be made without departing from the spirit and scope of the present disclosure as presently or hereafter claimed.

Further Information about Technical Background to this Application

The disclosure of the following Japanese Patent Application including specification, drawings and claims is incorporated herein by reference in its entirety: Japanese Patent Application No. 2019-238121 filed on Dec. 27, 2019.

### INDUSTRIAL APPLICABILITY

The present disclosure is applicable to a device or the like that optimizes, for example, a high bit precision neural network used for image recognition into a neural network installed in an installation environment such as a vehicle.

1. A neural network optimization method, comprising:
performing first processing of, for each of a plurality of preset layers included in a first neural network that outputs, upon input of evaluation data that indicates an object, a recognition result of the object, performing bit reduction that is processing of reducing bit precision of parameters that constitute the preset layer to derive a degree of influence exerted on the recognition result of the first neural network by the bit reduction performed on the layer; and
performing second processing of performing the bit reduction on each of at least one of the plurality of preset layers included in the first neural network that is identified based on the degree of influence derived for each of the plurality of preset layers to generate a second neural network.

2. The neural network optimization method according to claim 1,
wherein, in the first processing,
when deriving the degree of influence for a deriving target layer that is one of the plurality of preset layers included in the first neural network,
the degree of influence of the deriving target layer is derived by calculating a difference between a first evaluation value and a second evaluation value, the first evaluation value being a value based on a recognition result obtained when the bit reduction is not performed on the deriving target layer, and the second evaluation value being a value based on a recognition result obtained when the bit reduction is performed on the deriving target layer.

3. The neural network optimization method according to claim 2,
wherein, in the first processing,
a low precision neural network is generated by performing the bit reduction on each of the plurality of preset layers included in the first neural network,
output data output from each of a plurality of layers included in the low precision neural network is acquired by forward propagation of the low precision neural network upon input of the evaluation data, and
when, in the first neural network, a preceding adjacent layer is present adjacent to the deriving target layer on an input side, and a succeeding adjacent layer is present adjacent to the deriving target layer on an output side:
the output data from a low precision preceding adjacent layer that is one of the plurality of layers included in the low precision neural network and corresponds to the preceding adjacent layer is input into the deriving target layer on which the bit reduction is not performed, as preceding adjacent layer output data;
the first evaluation value is derived based on a recognition result obtained by forward propagation of the first neural network upon input of the preceding adjacent layer output data into the deriving target layer;
the output data from a low precision deriving target layer that is one of the plurality of layers included in the low precision neural network and corresponds to the deriving target layer is input into the succeeding adjacent layer on which the bit reduction is not performed, as deriving target layer output data; and
the second evaluation value is derived based on a recognition result obtained by forward propagation of the first neural network upon input of the deriving target layer output data into the succeeding adjacent layer.

4. The neural network optimization method according to claim 3,
wherein, in the second processing,
at least one layer whose degree of influence is less than or equal to a threshold value is identified from among the plurality of preset layers included in the first neural network, and
the bit reduction is performed on each of the at least one layer identified.

5. The neural network optimization method according to claim 4, further comprising:
performing third processing of deriving a third evaluation value that is an evaluation value based on a recognition result output upon input of the evaluation data into the second neural network, the third evaluation value increasing with an increase in object recognition accuracy; and
performing fourth processing of updating the threshold value by increasing the threshold value when the third evaluation value is greater than a target value,
wherein the second processing, the third processing, and the fourth processing are repeatedly executed by using the second neural network as a new first neural network and the threshold value updated, and
in the second processing that is repeatedly executed,
at least one layer whose degree of influence is less than or equal to the threshold value updated is identified from at least one of the plurality of preset layers included in the new first neural network, the at least one of the plurality of preset layers not being subjected to the bit reduction yet.

6. The neural network optimization method according to claim 3,
wherein, in the second processing,
one layer whose degree of influence is lowest is identified from among the plurality of preset layers included in the first neural network, and
the bit reduction is performed on the one layer identified.

7. The neural network optimization method according to claim 6, further comprising:
performing third processing of deriving a third evaluation value that is an evaluation value based on a recognition result output upon input of the evaluation data into the second neural network, the third evaluation value increasing with an increase in object recognition accuracy,
wherein the second processing and the third processing are repeatedly executed by using the second neural network as a new first neural network when the third evaluation value is greater than a target value, and
in the second processing that is repeatedly executed,
one layer whose degree of influence is lowest is identified from among at least one of the plurality of preset layers included in the new first neural network, the at least one of the plurality of preset layers not being subjected to the bit reduction yet.

8. The neural network optimization method according to claim 6, further comprising:
performing third processing of deriving a third evaluation value that is an evaluation value based on a recognition result output upon input of the evaluation data into the second neural network, the third evaluation value increasing with an increase in object recognition accuracy,
wherein the first processing, the second processing, and the third processing are repeatedly executed by using the second neural network as a new first neural network when the third evaluation value is greater than a target value.

9. The neural network optimization method according to claim 5,
wherein, when the second processing and the third processing are repeatedly executed, and the third evaluation value derived in the third processing executed last is less than the target value,
the second neural network generated by the second processing executed immediately before the second processing performed last is output as a final neural network.

10. A neural network optimization device, comprising:
a first processing unit that performs, for each of a plurality of preset layers included in a first neural network that outputs, upon input of evaluation data that indicates an object, an object recognition result, bit reduction that is processing of reducing bit precision of parameters that constitute the preset layer to derive a degree of influence exerted on the recognition result of the first neural network by the bit reduction performed on the layer; and
a second processing unit that performs the bit reduction on each of at least one of the plurality of preset layers included in the first neural network that is identified based on the degree of influence derived for each of the plurality of preset layers to generate a second neural network.

11. A neural network optimization device, comprising:
a processor; and
a memory,
wherein the processor performs first processing and second processing by using the memory,
the first processing being processing of, for each of a plurality of preset layers included in a first neural network that outputs, upon input of evaluation data that indicates an object, a recognition result of the object, performing bit reduction that is processing of reducing bit precision of parameters that constitute the preset layer to derive a degree of influence exerted on the recognition result of the first neural network by the bit reduction performed on the layer, and
the second processing being processing of performing the bit reduction on each of at least one of the plurality of preset layers included in the first neural network that is identified based on the degree of influence derived for each of the plurality of preset layers to generate a second neural network.
